(19) United States
(12) Patent Application Publication
(10) Pub. No.: US 2009/0134600 A1
(43) Pub. Date: May 28, 2009

(54) Gooseneck Frame for Recreational Vehicle

(76) Inventor: Lawton Tinley, Fitzgerald, GA (US)

Correspondence Address: WHYTE HIRSCHBOECK DUDEK S C;INTELLECTUAL PROPERTY DEPARTMENT, 555 EAST WELLS STREET, SUITE 1900, MILWAUKEE, WI, 53202, US

(21) Appl. No.: 11/944,832

(22) Filed: Nov. 26, 2007

(51) Int. Cl. B62D 33/00; B62D 53/06

(52) U.S. Cl. 280/441.2; 296/182.1

(57) ABSTRACT

Disclosed is a gooseneck frame trailer designed to tow recreational vehicles. Also disclosed is a recreational vehicle combined with a gooseneck frame trailer for easier and advantageous towing. The use of a gooseneck frame trailer for this purpose is beneficial over existing fifth wheel art in many respects. It is easier to use, is less expensive and provides more maneuverability and better weight distribution when towing. It also provides more storage space on both the trailer and tow vehicle than previous designs and methods available and additionally provides storage areas and at least one storage container in certain embodiments. The use of this invention also decreases the number of stairs required to access the interior of the recreational vehicle. Also disclosed is a method for towing a recreational vehicle by mounting the recreational vehicle on a gooseneck frame trailer.

### BACKGROUND OF THE INVENTION

The present invention relates to a gooseneck frame used to tow a recreational vehicle, a recreational vehicle in combination with a gooseneck frame and a method for towing a recreational vehicle with a gooseneck frame.

Heavier recreational vehicles are generally towed by a fifth wheel coupling device. The fifth wheel coupling provides a link between the recreational vehicle and the towing truck. In such circumstances, the coupling is installed in the bed of the towing vehicle. This coupling consists of a horseshoe-shaped coupling device mounted between the wheel wells in the bed of the towing vehicle which attaches to the fifth wheel hitch pin under the upper extended portion of the recreational vehicle. In the fifth wheel design, the recreational vehicle's extended portion extends over the bed of the towing vehicle when hitched.

There are several disadvantages in using a fifth wheel device for towing purposes. Fifth wheel devices tend to be heavy and also expensive to purchase and install. The use of a fifth wheel device also eliminates storage space that would otherwise be available in the bed of the towing vehicle. Furthermore, use of a fifth wheel device requires the user to carry heavy wheel plates back and forth when they use their recreational vehicle.

Another disadvantage to the use of a fifth wheel towing method with a recreational vehicle is that the design requires that the living areas be on two or more levels. This requires that the bedroom and bath be accessed by stairs.

Another method of towing is with a conventional travel trailer method. This design provides for one level of living space. However, stability and maneuverability is poor in this design. The turning radius is limited and backing up the unit can be difficult. Additionally, when a conventional method of towing is used, the hitch weight is centered on the bumper of the towing vehicle, whereas it is more advantageous to have the weight distribution forward of the rear axle. Approximately two (2) inches forward of the rear axle is preferred.

Accordingly, there is a need for towing means for larger and heavier recreational vehicles that provides an easy method of hooking up and disconnecting the trailer from the towing vehicle. There is also a need for a towing means that provides improved weight distribution, maneuverability and stability, as well as easy backing up and parking of the recreational vehicle. There is also a need to provide towing means that reduces the substantial cost of a fifth wheel device. There is also a need for a device for towing larger recreational vehicles that allows towing to be accomplished with a smaller vehicle. There is additionally a need for a towing device for larger recreational vehicles that provides for more storage space, both on the trailer and in the back of the towing vehicle to better serve the camper's and traveler's needs. There is also a need for a towing device that eliminates the need to climb steps to go from living areas to bath and bedroom areas, particularly for elderly or disabled customers by providing additional floor space on one level in the relatively same size recreational vehicle.

### SUMMARY OF THE INVENTION

The invention, which is defined by the claims set out at the end of this disclosure, is intended to solve at least some of the problems noted above.

A gooseneck frame of a size and configuration to support and tow a recreational vehicle is shown and described herein. The gooseneck frame may or may not include a storage container thereon. The storage container, if provided, may be removably affixed to the frame. It may alternatively be permanently affixed to the frame. The storage container could be of various sizes and shapes and could also provide for secured storage by locking.

A significant advantage of the invention is that the combination of the gooseneck frame and recreational vehicle may be hitched to and towed by a motorized vehicle without a fifth wheel coupling device.

The recreational vehicle may be permanently mounted on the gooseneck trailer and the combined unit may provide for at least one storage container. At least one storage container may be removably attached to the unit. Alternatively, the container may be permanently affixed to the frame.

The storage container may be affixed to the front portion of the gooseneck frame. Other storage means may be additional options on the gooseneck frame.

A method of towing a recreational vehicle is also provided. The method comprises permanently mounting a recreational vehicle to a gooseneck trailer and hitching the gooseneck trailer to a towing vehicle.

### BRIEF DESCRIPTION OF THE DRAWINGS

FIG. 1 a side view of the gooseneck trailer on which a recreational vehicle is mounted, showing the combination in its environment, namely, how the combined unit is hitched to a towing vehicle.

FIG. 2 is a top perspective view of the gooseneck trailer of FIG. 1.

FIG. 3 is a perspective view of the front portion of the gooseneck trailer, with the rest of the trailer cut away, demonstrating how the front portion may be used for storage, with the back portion of the towing vehicle shown in phantom lines.

FIG. 4 is a perspective view of the front portion of the gooseneck trailer, with the rest of the gooseneck trailer broken away, showing a storage container mounted on the front portion of the gooseneck trailer.

Before explaining embodiments of the invention in detail, it is to be understood that the invention is not limited in its application to the details of construction and the arrangement of the components set forth in the following description or illustrated in the drawings. The invention is capable of other embodiments or being practiced or carried out in various ways. Also, it is to be understood that the phraseology and terminology employed herein is for the purpose of description and should not be regarded as limiting.

### DETAILED DESCRIPTION OF THE PREFERRED EMBODIMENT

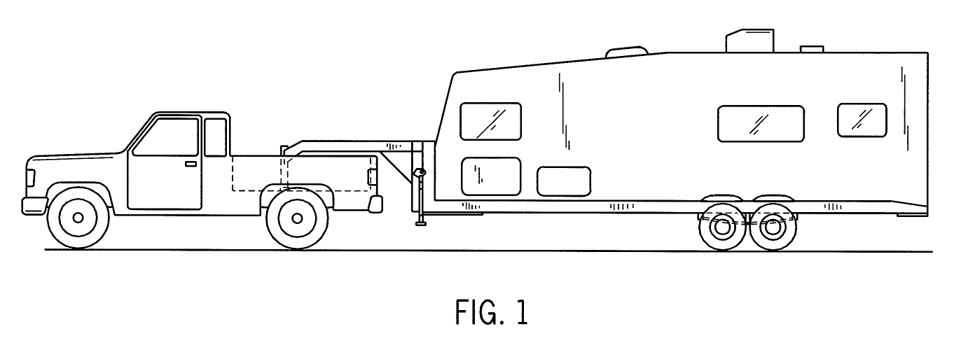

Referring to the drawings, FIG. 1 shows the recreational vehicle and gooseneck trailer combination 10 in its environment as hitched to and towed by a pickup truck or some other towing vehicle.

This method of towing a recreational vehicle provides substantial advantages over the primary method seen in the prior art of using a fifth wheel hitching device. A fifth wheel device is heavy, expensive and cumbersome. It eliminates storage space that would otherwise be available for use on both the trailer and in the bed of the towing vehicle. With the use of the gooseneck trailer of the current method, the hitch weight is more advantageously placed forward of the rear axle of the towing vehicle, rather than on its bumper. Importantly, the fifth wheel also requires greater height for accessing the recreational vehicle which presents challenges to users who may have difficulty climbing stairs.

In FIG. 1, a recreational vehicle 12 is mounted to a gooseneck trailer 14 for towing purposes, the gooseneck trailer 14 is constructed of a size and shape suitable to support the recreational vehicle 12. Generally, the weight anticipated of the combined recreational vehicle and gooseneck trailer may be in excess of 7,000 pounds with a carrying capacity of more than 2,000 pounds of cargo. However, it is intended that the invention may be modified in design to accommodate all sizes and shapes of gooseneck trailer/recreational vehicle combinations.

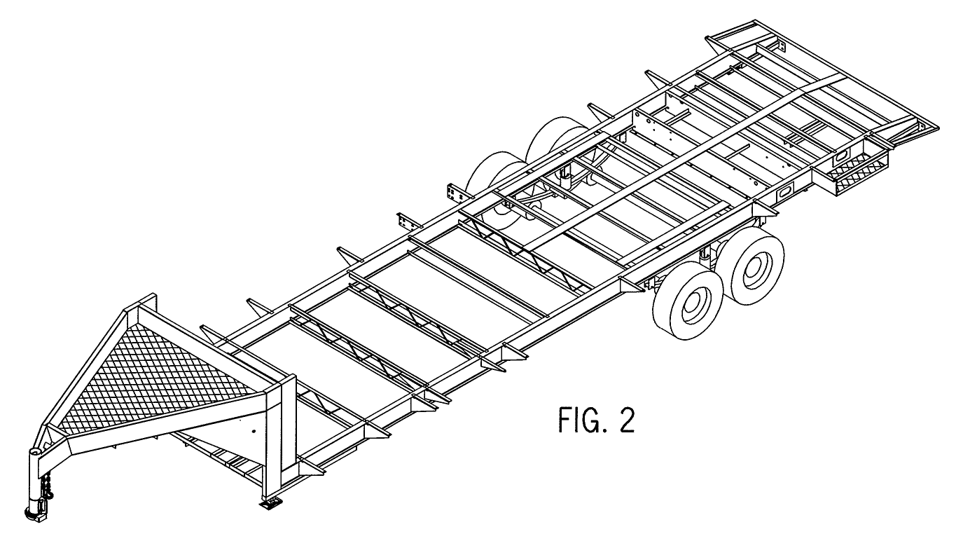

Referring to FIG. 2, the gooseneck trailer 10 is constructed of steel in the same manner as previously constructed and disclosed in the prior art. However, the construction must be of sufficient strength and stability to support a heavy recreational vehicle. Double axles 16 and wheels 18 are installed in back of the center portion 20 of the gooseneck trailer 14 for increased strength and stability.

In a preferred embodiment, the gooseneck trailer provides for a front storage area 22 in a front portion 24 as well as a side storage compartment 26 for gas or water tanks in a side rear portion 28. Other or alternative types of storage areas or compartments may also be provided.

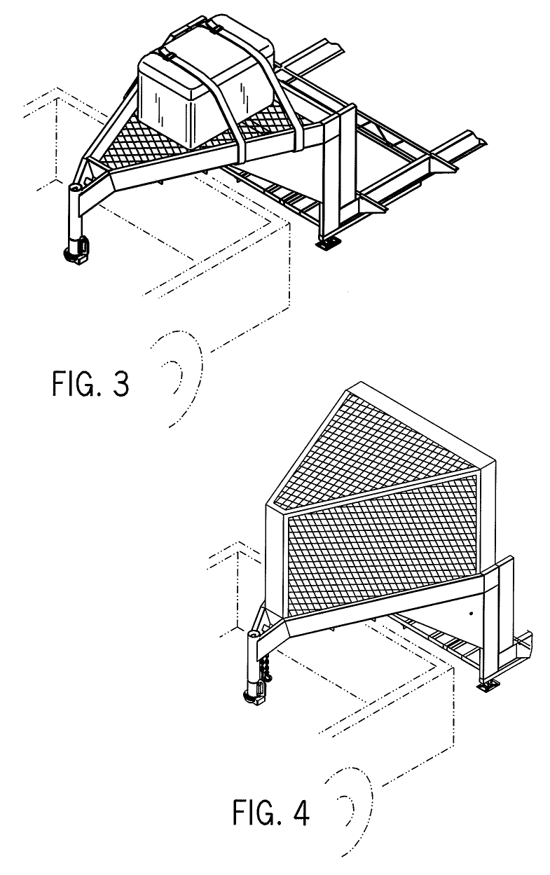

FIG. 3 demonstrates how the front storage area 22 may be used for storage purposes. A cooler, luggage, or other items can be strapped to the front portion 24 in the front storage area 22 by the use of bungee cords or other strapping means and thereby held securely to the gooseneck trailer 14 when the vehicle is in transit. Alternatively, a storage container 30 could be either permanently or removably affixed to the front portion 24 of the gooseneck trailer frame 14 as shown in FIG. 4.

The storage container 30 could vary in size, shape and composition, as desired for the items to be stored. It also could incorporate a locking feature to safely secure items stored therein from theft. The storage container 30 could be constructed of steel mesh or could be constructed of other materials, such as opaque plastic to prevent the contents of the storage container 30 from being visible from the outside, and to provide for a lighter container, particularly if the container is removable.

In another embodiment, the front storage area 22 could be used for recreational purposes when the trailer is parked. Users could sit on the front storage area 22 in lawn chairs to watch sporting events at a higher level off the ground if desired. Another alternative embodiment would provide a railing or other structure around the perimeter of the front storage area 22 for storage or safety purposes.

The invention also includes a method of towing a recreational vehicle by mounting the recreational vehicle on a gooseneck trailer. This method incorporates the stability and maneuverability of a fifth wheel hitching method with the lower cost and one-level living area of the conventional travel trailer.

It is understood that the various preferred embodiments are shown and described above to illustrate different possible features of the invention and the varying ways in which these features may be combined. Apart from combining the different features of the above embodiments in varying ways, other modifications are also considered to be within the scope of the invention.

The invention is not intended to be limited to the preferred embodiments described above, but rather is intended to be limited only by the claims set out below. Thus, the invention encompasses all alternate embodiments that fall literally or equivalently within the scope of these claims.

What is claimed is:

1. A gooseneck frame trailer of a size and configuration to support and tow a recreational vehicle.

2. The gooseneck frame trailer of claim 1, having at least one storage area thereon.

3. The gooseneck frame trailer of claim 2, having a front portion wherein at least one storage area is located in the front portion.

4. The gooseneck frame trailer of claim 3, having a storage container located in at least one storage area.

5. The gooseneck frame trailer of claim 4 wherein the storage container is removably affixed to the gooseneck frame trailer.

6. The gooseneck frame trailer of claim 1 supporting a recreational vehicle, wherein the combination gooseneck frame and recreational vehicle may be hitched to and towed by a motorized vehicle without a fifth wheel coupling device.

7. The gooseneck frame trailer of claim 6 permanently attached to a recreational vehicle, whereby the combination frame trailer and recreational vehicle may be hitched to and towed by a motorized vehicle.

8. The gooseneck frame trailer and recreational vehicle of claim 6 having at least one storage container thereon.

9. The gooseneck frame trailer and recreational vehicle combination of claim 8 wherein the storage container is removably attached to the gooseneck frame.

10. The gooseneck frame trailer and recreational vehicle combination of claim 8 wherein the storage container is enclosed.

11. The gooseneck frame trailer and recreational vehicle combination of claim 8 wherein the gooseneck frame has a front portion and further wherein the storage container is permanently mounted on the front portion.

12. A method of towing a recreational vehicle, the method comprising:
permanently mounting a recreational vehicle to a gooseneck trailer; and
hitching the gooseneck trailer to a towing vehicle.
